(19) United States
(12) Patent Application Publication
(10) Pub. No.: US 2013/0272032 A1
(43) Pub. Date: Oct. 17, 2013

(54) DC/DC VOLTAGE CONVERTER AND METHOD FOR OPERATING A DC/DC VOLTAGE CONVERTER

(71) Applicant: SMA Solar Technology AG, Niestetal (DE)

(72) Inventors: Jens-Uwe Mueller, Vellmar (DE); Torsten Leifert, Voegelsen (DE); Sebastian Heinze, Huettenberg (DE); Mario Willenberg, Kassel (DE)

(21) Appl. No.: 13/907,088

(22) Filed: May 31, 2013

Related U.S. Application Data
(63) Continuation of application No. PCT/EP2011/071643, filed on Dec. 2, 2011.

(30) Foreign Application Priority Data
Dec. 2, 2010 (DE) 102010060957.9

(51) Int. Cl. H02M 3/335

(52) U.S. Cl. CPC H02M 3/33569
USPC 363/17

(57) ABSTRACT

The disclosure relates to a method for operating a DC/DC voltage converter comprising a first switching bridge with at least two first switches coupled to an input of the DC/DC voltage converter, a second switching bridge with at least two second switches coupled to an output of the DC/DC voltage converter, a transformer and at least one capacitor, wherein the first switching bridge is connected to the second switching bridge via the transformer. The first switches are switched such that a resonant circuit formed by the transformer and the at least one capacitor is operated in resonance, and the second switches are switched at the same clock frequency with a phase shift compared to the first switches, such that the second switches are switched prior to the first switches. The disclosure also relates to a DC/DC voltage converter comprising a control circuit for the first and second switches which is configured to carry out the method, and to a backup power system including such a DC/DC voltage converter.

### REFERENCE TO RELATED APPLICATIONS

This application is a continuation of International Application Number PCT/EP2011/071643 filed on Dec. 2, 2011, which claims priority to German Application number 10 2010 0609 57.9 filed on Dec. 2, 2010.

### FIELD

The disclosure relates to a method for operating a DC/DC voltage converter comprising a first switching bridge having at least two first switches, a second switching bridge having at least two second switches, a transformer, at least one capacitor and a control circuit for the first and second switches. The disclosure also relates to a DC/DC voltage converter configured to carry out the method and to a backup power system which has such a DC/DC voltage converter.

### BACKGROUND

Direct Current (DC) to Direct Current voltage converters, subsequently called DC/DC converters, are used, by way of example, as input stages for an inverter, for example in a photovoltaic installation, a fuel cell heating system or for battery-powered backup power systems for a local power supply grid. In principle, a wide variety of topologies and operating methods are known for DC/DC converters. In order to transmit relatively high powers, such as in the aforementioned instances of application, DC/DC converters of the type cited at the outset are particularly suitable.

In many instances of use, the voltage from a current source feeding the DC/DC converter is not constant. By way of example, it changes in a photovoltaic installation when the operating point of photovoltaic modules in the photovoltaic installation is varied on the basis of irradiation and load. In the case of a battery-powered backup power system, the battery voltage—as the input voltage for the DC/DC converter—is dependent on the transmitting load and the charge state of the battery. Equally, the cell voltage of a fuel cell as the input voltage for the DC/DC converter varies to a particular degree in the low-load range. In such cases, it is desirable to provide at the output of the DC/DC converter a voltage which is as constant as possible as an input voltage for a circuit connected downstream of the DC/DC converter, for example an inverter bridge in the inverter. For a varying input voltage, this presupposes a variable voltage transformation ratio for the DC/DC converter.

In a further implementation, backup power systems are operated using different current sources, the term current sources being understood within the context of the application as charge storage devices, such as capacitors, and energy storage devices, in which the energy is stored in nonelectrical form, for example in chemical form (as is the case with batteries or fuel cells) and is converted into electrical energy when needed, and also generators, such as photovoltaic generators. In this case, the conversion into electrical energy may be irreversible or reversible.

Particularly when using different types of current sources within a backup power system, a large voltage variation may arise at an input of a DC/DC converter connected upstream of an inverter in the backup power system. In order to adapt to this voltage variation, the connected DC/DC converter needs to have a corresponding range of variation for the voltage transformation ratio.

The European patent application No. 10 155 828.6 from the applicant, which has not been published previously, discloses varying the voltage transformation ratio of a DC/DC converter by varying the clock frequency at which the switches of a DC/DC converter are actuated and by using a variable duty ratio (switched-on time to switched-off time of a switch within one clock period). In addition, this application discloses the parallel use of a plurality of DC/DC converters having various control parameters for clock frequency and duty ratio. In this way, the voltage transformation ratio can be varied by up to a factor of three. However, an implementation with a plurality of parallel DC/DC converters requires the use of additional components, particularly additional power semiconductors as switches for the DC/DC converters.

The document US 2009/0034299 A1 discloses a DC/DC converter and a method for operating a DC/DC converter wherein the switches of an input stage are switched prior to the switches of an output stage of the DC/DC converter. Compared to a synchronous switching of corresponding switches of the input and output stages, the late switching of the switches of the output stage leads to a decreased output voltage. Accordingly, a variation towards a lower output voltage is possible, thereby increasing the range of the voltage transformation ratio. However, a further decrease of the output voltage is often not desired.

### SUMMARY

The present disclosure provides a method of operation for a DC/DC converter which can be used to vary the voltage transformation ratio further towards larger values without extensive use of extra components and while providing effective power transmission. The present disclosure provides a DC/DC converter which is configured to carry out the method of operation and a backup power system based on such a DC/DC converter.

In accordance with a first embodiment, the DC/DC converter comprises a first switching bridge with at least two first switches coupled to an input of the DC/DC voltage converter, and a second switching bridge with at least two second switches coupled to an output of the DC/DC voltage converter. The DC/DC converter further comprises a transformer and at least one capacitor, wherein the first switching bridge is connected to the second switching bridge via the transformer. In one embodiment the first switches are switched such that a resonant circuit formed by the transformer and the at least one capacitor is operated in resonance, and the second switches are switched at the same clock frequency with a phase shift in relation to the first switches, such that the second switches are switched prior to the first switches.

The phase shift results in time periods in which a first switch and a second switch are closed at the same time, which results in an additional flow of current in the transformer. This flow of current results in a deposition of energy in stray inductances in the transformer. The self-induced voltage thereof in turn results in an increased voltage on the secondary side of the transformer. Consequently, the output voltage rises compared to a situation without a phase shift or compared to a situation, in which switches of the output side are switches after the switches of the input side. Accordingly the voltage transformation ratio is increased.

In one embodiment, the first and second switches are switched on at zero voltage and/or at zero current, which results in a high level of efficiency for the DC/DC voltage conversion.

In a further embodiment, the phase-shifted switching of the second switches is effected with a phase shift of greater than 0° and less than 180°, particularly less than 90°. This allows a particularly great variation in the output voltage, which is equivalent to a great variation in the voltage transformation ratio.

In accordance with a second embodiment, the object is achieved by a DC/DC converter comprises a first switching bridge having at least two first switches, and a second switching bridge having at least two second switches. The DC/DC converter further comprises a transformer having at least one coil, at least one capacitor and a control circuit for the first and second switches. The DC/DC converter is configured to carry out a method according to the aforementioned first embodiment.

In accordance with a third embodiment, a backup power system comprises has at least two different current sources and a DC/DC converter according to the aforementioned second embodiment. The advantages of the second and third embodiment correspond to those of the first embodiment.

In accordance with yet another embodiment, a DC/DC voltage converter, comprises a first switching bridge configured as a full bridge that comprises at least four first switches, wherein the first switching bridge is coupled to an input of the DC/DC voltage converter. The DC/DC voltage converter further comprises a second switching bridge that comprises at least two second switches coupled to an output of the DC/DC voltage converter, and a transformer coupled between the first switching bridge and the second switching bridge. In addition, the DC/DC voltage converter comprises at least one capacitor, and a switching control circuit configured to provide control signals to the first switching bridge and the second switching bridge. The switching control circuit is configured to provide control signals such that the first switches are switched in crosswise synchronicity to form a resonant circuit via the transformer and the at least one capacitor. Further, the switching control circuit is configured to provide control signals such that the second switches are switched at the same clock frequency with a phase shift compared to the first switches.

### BRIEF DESCRIPTION OF THE DRAWINGS

The disclosure is explained in more detail below using embodiments with reference to six figures, in which:

FIG. 1 shows a schematic diagram of a first embodiment of a DC/DC converter,

FIG. 2 shows time profiles for actuating signals and for currents flowing inside a DC/DC converter in the first embodiment of a method of operation for a DC/DC converter,

FIG. 3 shows a schematic circuit diagram of a second embodiment of a DC/DC converter,

FIG. 4 shows a schematic circuit diagram of a third embodiment of a DC/DC converter,

FIG. 5 shows time profiles for actuating signals and for currents flowing inside a DC/DC converter in the second embodiment of a method of operation for a DC/DC voltage converter, and

FIG. 6 shows a block diagram of a backup power system with various current sources and a DC/DC converter.

### DETAILED DESCRIPTION

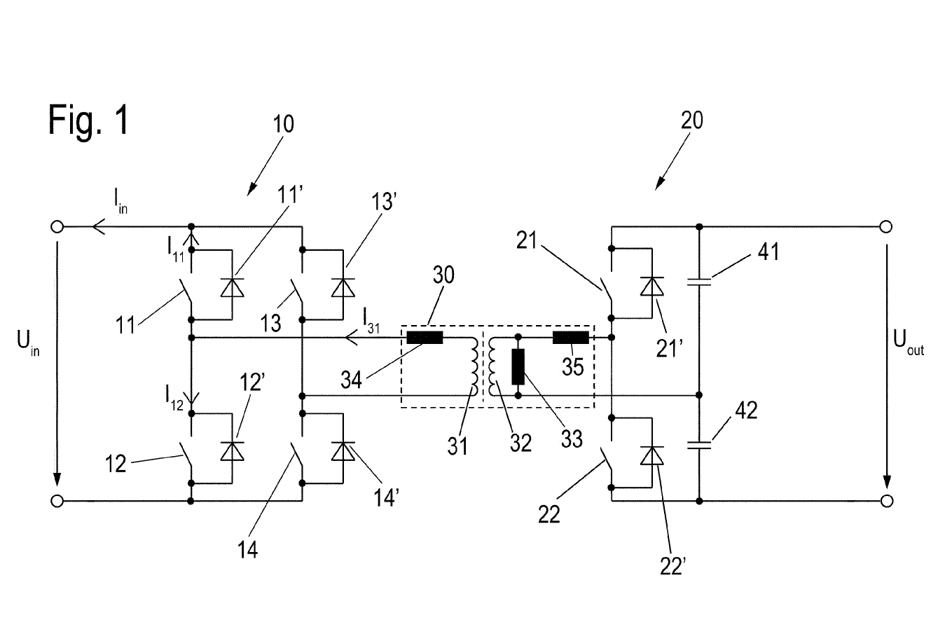

FIG. 1 shows a schematic diagram of a first embodiment of a DC/DC converter. The DC/DC converter comprises a first switching bridge 10 and a second switching bridge 20 which are connected to one another via a transformer 30. By way of example, the voltage applied to the first switching bridge 10 is referred to as the input voltage Uᵢₙ and the voltage provided by the second switching bridge 20 is referred to as the output voltage Uₒᵤₜ. As explained in more detail below, both switching bridges 10, 20 are equipped with active switching elements, so that the DC/DC converter shown can be operated bi-directionally. In this respect, the association between input and output voltages and the switching bridges 10, 20 and the related classification into an input stage and an output stage are merely exemplary and non-limiting. In this context, for the purposes of simpler illustration, the text below also refers to the first switching bridge 10 as the primary switching bridge 10 and also refers to the second switching bridge 20 as the secondary switching bridge 20.

In the embodiment shown, the primary switching bridge 10 is in the form of what is known as a full or H bridge having two bridge paths, each with two first switches 11, 12 and 13, 14. For the sake of simplicity, the first switches 11-14 are subsequently also referred to as primary switches 11-14. Symbolically, simple switch symbols are shown for the switching bridges in all figures of the application. However, it is to be understood that all switches shown in the switching bridges in one embodiment are actuatable semiconductor switches, particularly power semiconductor switches. It is known to use MOSFETs (Metal Oxide Semiconductor Field Effect Transistors) or bipolar transistors, in the latter case particularly IGBTs (Insulated Gate Bipolar Transistors). For each of the first switches 11 to 14, an antiparallel freewheeling diode 11′ to 14′ is provided. In some types of power semiconductor switches, particularly in MOSFETs, the freewheeling diode 11′ to 14′ is already integrated in the switches 11 to 14.

The secondary switching bridge 20 is in the form of a half or single bridge with only one active bridge path and accordingly has two second switches 21, 22, which are subsequently also referred to as secondary switches 21, 22. For the secondary switches 21, 22, an antiparallel freewheeling diode 21′ and 22′ is again provided in each case.

In one alternative embodiment, the secondary switching bridge 20 may also be formed by a full bridge having two active bridge paths. In that case, the DC/DC converter may also be of unidirectional design. In the case of such a refinement, each bridge path has only one active secondary switch, preferably the lower switch, whereas the other secondary switch is in the form of a passive switch, for example in the form of diodes. Accordingly, only one half of the two bridge paths is clocked in each case.

In the embodiment shown, the transformer 30 is designed to provide DC isolation as a high-frequency transformer having a first winding 31 and a second winding 32, which are in turn are also referred to as a primary winding 31 and a secondary winding 32 without defining one direction for the power transmission. The transformer 30 may have a transformation ratio of 1:1 or may be of voltage-transforming design. The fixed transformation ratio has no influence on the variation in the voltage transformation ratio of the DC/DC converter.

As an alternative embodiment, it is likewise possible for the transformer 30 not to be designed to provide DC isolation. The transformer 30 then comprises two current paths, each between one of the bridge paths in the primary switching bridge 10 and one of the bridge paths in the secondary switching bridge 20, for example, and also an arrangement comprising two inductances, with one inductance being arranged in one of the current paths while the other inductance is situated between the two current paths connecting the bridges. When the text below refers to a DC-isolating design of the transformer 30, this is intended to be understood to be merely exemplary and non-limiting.

Each bridge path has a center tap between its two series-connected primary and secondary switches 11, 12 or 13, 14 and 21, 22. The center taps of the two bridge paths in the primary switching bridge 10 are routed to the primary winding 31 of the transformer 30. The secondary winding 32 is connected with one tap to the center tap of the half bridge in the secondary switching bridge 20 and with another tap to a center tap of a passive bridge path formed by a series circuit comprising two capacitors 41 and 42, the passive bridge path being arranged in parallel with the bridge path formed by the secondary switches 21 and 22 in the secondary bridge 20.

FIG. 1 shows the transformer 30 with a main inductance 33 and also a primary-side and a secondary-side stray inductance 34 and 35 in the manner of an equivalent circuit diagram. In this case, the main inductance 33 forms a resonant circuit with the capacitors 41, 42, wherein the resonant circuit defines a resonant frequency for the DC/DC converter.

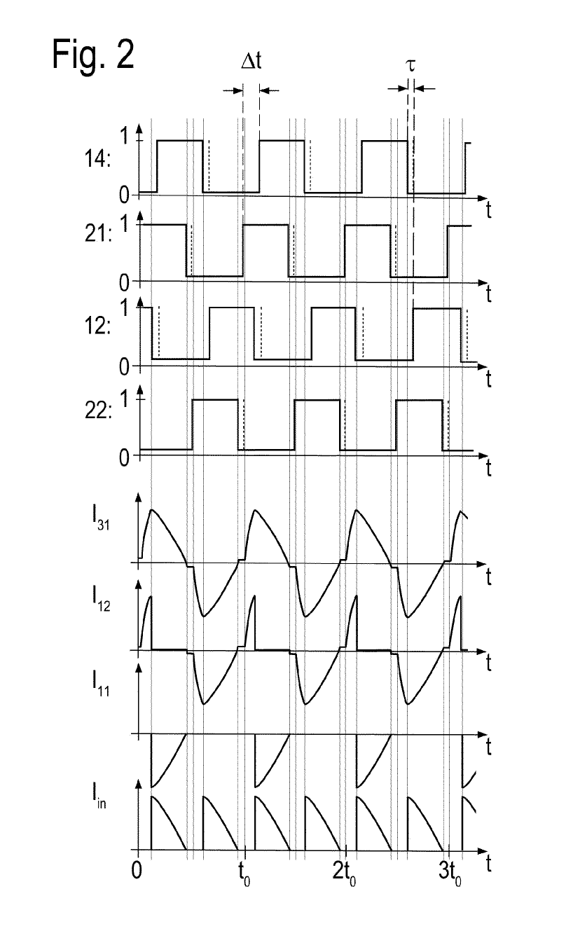

FIG. 2 uses voltage profiles for actuating signals for switches in a DC/DC converter and for currents flowing inside the DC/DC converter to illustrate the first embodiment of a method of operation for a DC/DC converter. The method of operation as shown in FIG. 2 can be carried out by the DC/DC converter shown in FIG. 1, for example. It is explained below by way of example with reference to FIG. 1.

The upper part of FIG. 2 shows the voltage profiles for actuating signals for the primary switches 12 and 14 and the secondary switches 21, 22 as a function of time t in four graphs. As an aid to comprehension, the actuating signals for the upper switches 11 and 13 are not discussed explicitly. The actuating signals are the same for the primary switches 11 and 14 and 12 and 13, for example, when the primary switching bridge 10 is operated in crosswise synchronicity.

The time axis is the same for all graphs in FIG. 2. The relevant actuating signals are therefore all combined in one graph (cf. 1^{st} and 4^{th} graph from the top). In the case of the actuating signals, a “1” denotes a switched-on switch and a “0” denotes a switched-off switch in each case.

In one embodiment the two switches in a bridge path are each alternately switched on and off, each of the switches in a bridge path being on and off for the same length of time within a clock period to. In this embodiment, provision is made for a short dead time t between the opening of one of the switches in the path, e.g. the primary switch 11, and the closing of the other switch in the same bridge path, for example the primary switch 12. In this way, even in the presence of a switching(-off) delay, there is the provision that both switches in a bridge path are not simultaneously on and do not short the input current source.

Similarly, there may be provision for a corresponding dead time for the switching processes in the secondary bridge too, the dead times in the two bridges also being optionally different. The duty ratio defined is the ratio of the switched-on period to the switched-off period of a switch within the clock period t₀. In the present case, the duty ratio is somewhat less than 1 on account of the dead time for all switches.

The actuating signals for the primary switches and the secondary switches in principle exhibit the same profile, but have a phase shift relative to one another. In the embodiment illustrated, the actuating signal for the secondary switch 21 leads that of the primary switch 14, and the actuating signal for the secondary switch 22 leads that of the primary switch 12 by a time difference Δt, which corresponds to a phase shift of approximately 30° in the example. In this embodiment, all switches, i.e. the primary switches 11-14 and the secondary switches 21, 22, are soft-switched, ensuring high efficiency for the DC/DC converter.

The effect of this phase shift becomes clear from the current profiles shown in the lower region of FIG. 2. The four graphs in the lower region of FIG. 2 show the flow of current I₃₁ through the primary coil 31, the flows of current and I₁₂ through the primary switches 11 and 12 and the flow of load current Iᵢₙ at the input terminals of the primary switching bridge 10 as a function of time on the same timescale as in the upper region. The phase shift described previously results in an additional flow of current through the primary coil 31 in the time periods in which the primary switch 12 and the secondary switch 21 are closed at the same time. This flow of current results in energy deposition in the primary stray inductance 34 and the secondary stray inductance 35. The self-induction voltage thereof in turn results in an increased voltage on the secondary side of the transformer 30.

As a consequence, the output voltage Uₒᵤₜ is increased in comparison to a situation without a phase shift between the switches of the primary switching bridge 10 and the secondary switching bridge 20. By varying the angle of the phase shift between 0° and 180°, it is possible to influence the magnitude of the voltage increase and thus to vary the voltage transformation ratio. For effective energy transmission, phase shift values of less than 90° are advantageous.

However, when the DC/DC converter is loaded on the output side, the connection of the main inductance 33 of the transformer 30 in parallel with a series circuit comprising the stray inductance 35, the capacitors 41, 42 and a load resistor results in an inherent phase shift between the primary-side and secondary-side currents in the case of the transformer 30. This inherent phase shift should advantageously also be considered when using the method described according to one embodiment. The time difference Δt should therefore be related not to the switching time of the primary switches but rather to the time at which there would be no voltage applied to the secondary switches 21, 22 if they were not activated. The time difference Δt to be applied can be corrected arithmetically as appropriate when the magnitudes of the inductances 33-35 of the transformer 30 and of the capacitances of the capacitors 41, 42 are known and when the load is known, for example by measurement. Alternatively, a current sensor can be used to identify a zero crossing in the current in the secondary bridge 20, for example at a secondary-side output of the transformer 30, or this time can be determined by detecting the voltage drop across the switch that is to be controlled. Even under load, the time of the zero crossing in the current corresponds to the relevant time from which the time difference Δt can be applied. As a further alternative or additional measure, the time difference Δt and hence the phase shift can also be adjusted as control parameters for regulation of the output voltage Uₒᵤₜ. The dependency of the output voltage Uₒᵤₜ on the phase shift is not linear, however, which is advantageously taken into account for control.

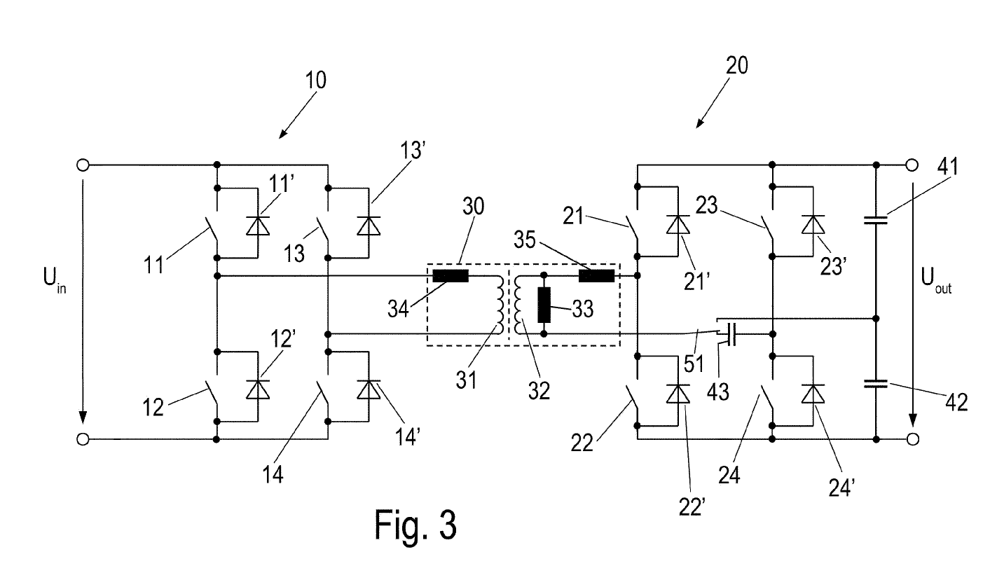

FIG. 3 shows a second embodiment of a DC/DC converter. In this as in the subsequent embodiments, identical reference symbols denote elements which are the same or have the same effect as in the embodiment in FIG. 1.

The DC/DC converter shown in FIG. 3 again comprises a first switching bridge 10 and a second switching bridge 20 which are connected to one another via a transformer 30. As discussed previously, the first switching bridge 10 is referred to as a primary switching bridge 10 and the second switching bridge 20 is referred to as a secondary switching bridge 20, by way of example. With regard to the structure of the primary switching bridge 10 and the transformer 30, reference is made to the first embodiment shown in FIG. 1.

In contrast to the first embodiment, the secondary switching bridge 20 has—besides a first active half bridge path, formed by two secondary switches 21 and 22 and a passive bridge path, comprising capacitors 41 and 42—a further active half bridge path. The further active half bridge path is formed by two further secondary switches 23 and 24. The further secondary switches 23 and 24 are likewise complemented by antiparallel freewheeling diodes 23′ and 24′.

The center tap of the active bridge path formed by the secondary switches 21 and 22 is connected to a tap on the secondary winding 32 of the transformer 30, whereas a second tap of the secondary winding 32 is connected via a changeover switch 51 either to a center tap of the passive bridge path or to a center tap of the second active bridge path, formed by the secondary switches 23 and 24, via a further capacitor 43. The changeover switch 51 may be an electromechanical changeover switch, for example a relay, or may be formed by a bi-directional semiconductor switch arrangement.

The changeover switch 51 allows the secondary switching bridge 20 to be operated in two different modes in which the output voltage Uₒᵤₜ differs by a factor of two given an otherwise identical input voltage Uᵢₙ and identical operating conditions.

In the first mode, the secondary winding 32 is connected to the passive bridge path. This corresponds precisely to the mode described in connection with the exemplary embodiment in FIG. 1 and the method of operation in FIG. 2.

In the second mode, on the other hand, the changeover switch 51 is used to connect the secondary winding 32 to the active half bridge formed by the second switches 23 and 24. In this case, the further secondary switch 24 is switched in synchronicity with the secondary switch 21, and the second further secondary switch 23 is switched in synchronicity with the secondary switch 22. Accordingly, the two secondary-side active bridge paths form a full or H bridge, the further capacitor 43 acting as a resonance capacitor for the DC/DC converter. In this second mode, the output produces half the output voltage Uₒᵤₜ compared to the first mode. In other words, the changeover switch 51 either connects or disconnects the voltage doubler circuit formed by the passive bridge path with the capacitors.

In each of the two modes, the opportunity for variation—described in connection with FIG. 2—of the transformation ratio of the DC/DC converter is available as a result of the introduction of a phase shift between the primary switches 11 to 14 in the primary switching bridge 10 and the secondary switches 21 to 24 in the secondary switching bridge 20. The combination of phase shift and changeover by means of the changeover switch 51 therefore extends the voltage transformation range of the DC/DC converter further.

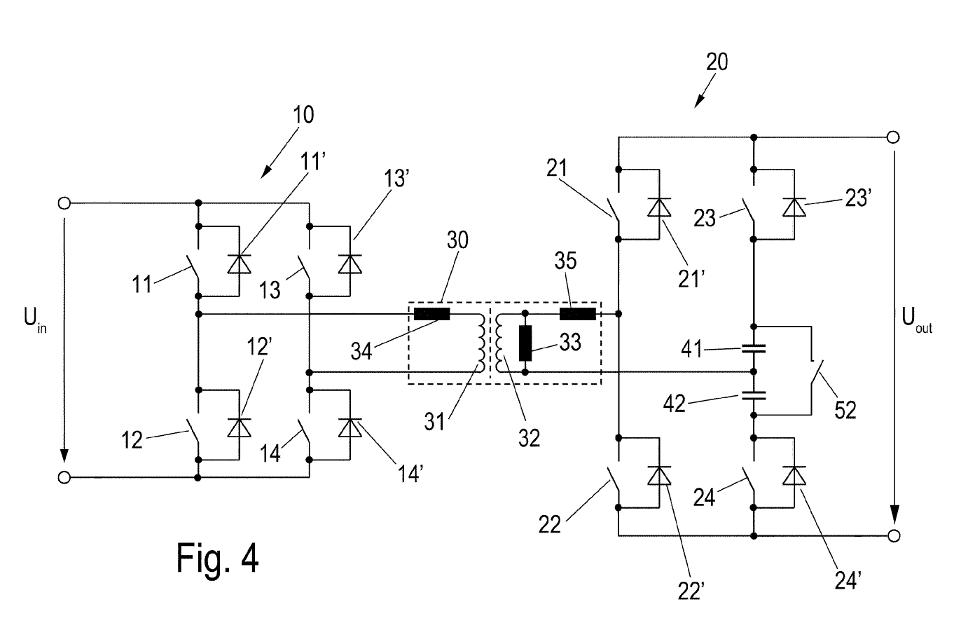

FIG. 4 shows a third embodiment of a DC/DC converter, again comprising a first switching bridge 10, also called the primary switching bridge 10, a second switching bridge 20, also called the secondary switching bridge 20, and a transformer 30. With regard to the design of the primary switching bridge 10 and the transformer 30, reference is made to the previous embodiments.

The secondary switching bridge 20 again comprises a first half bridge path with two second switches (secondary switches) 21, 22 and corresponding antiparallel freewheeling diodes 21′ and 22′, the center tap of which is connected to a connection on the secondary winding 32 of the transformer 30. In addition, the secondary switching bridge 20 is provided with a second bridge path which is formed by a series circuit comprising a third secondary switch 23, two capacitors 41, 42 and a fourth secondary switch 24. The secondary switches 23 and 24 are each again complemented by an antiparallel freewheeling diode 23′ and 24′.

Between the capacitors 41 and 42 of this bridge path, there is a center tap which is connected to the second connection of the secondary winding 32. A switch 52 is arranged in parallel with the series circuit comprising the capacitors 41 and 42.

As when using the changeover switch 51 in the embodiment in FIG. 3, operating the switch 52 in this embodiment allows the secondary switching bridge 20 to be operated in two different modes. In a first mode, the switch 52 is open and the secondary switches 23 and 24 are permanently closed. This mode substantially corresponds to the mode of the secondary switching bridge in the first embodiment in FIG. 1 and to the first mode in the second embodiment in FIG. 3. As a result of the closed secondary switches 23 and 24 and the associated freewheeling diodes 23′ and 24′, the capacitors 41 and 42 are connected directly to the output lines of the secondary switching bridge 20 in this mode.

In a second mode, the switch 52 is closed and the third and fourth secondary switches 23 and 24 are switched in crosswise synchronicity with the secondary switches 22 and 21, as in the case of a full or H bridge. This mode substantially corresponds to the second mode from the embodiment in FIG. 3 and likewise involves an output voltage Uₒᵤₜ which is halved in comparison with the first mode.

In contrast to the changeover switch 51 in the embodiment in FIG. 3, in this case the switch 52 is a simple switch replacing the changeover switch 51, which is more difficult to implement at least with semiconductor elements. In addition, in the case of the second embodiment shown in FIG. 3 with the capacitor 43, a separate resonance capacitor is required for the second mode. In the embodiment in FIG. 4, on the other hand, the capacitors 41 and 42 act as resonance capacitors in both modes. A separate resonance capacitor is therefore not needed.

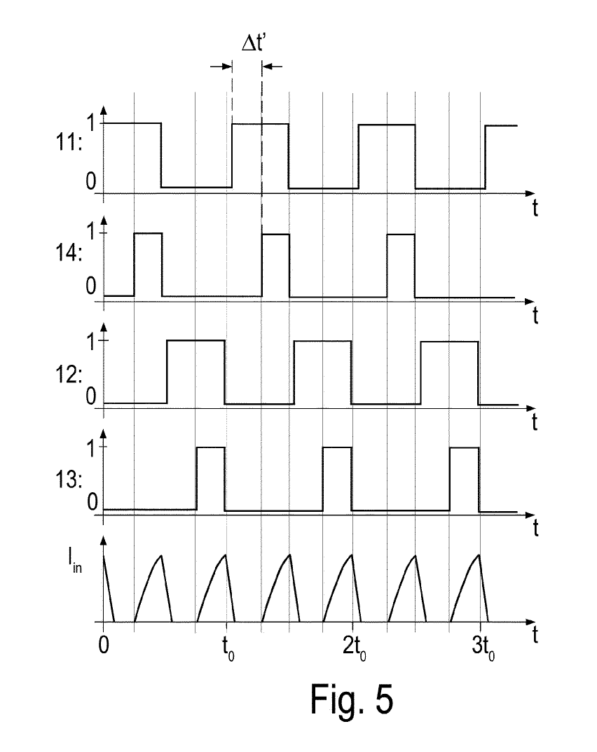

Besides the option shown in FIG. 4 for the additional variation of the transformation ratio, it is possible to combine further methods with the phase shift between the primary switching bridge and the secondary switching bridge which is described in connection with FIGS. 1 and 2. A further method is shown in FIG. 5, and may be carried out using the DC/DC converter shown in FIG. 1, for example, and is explained below with reference to this figure.

In a similar manner to FIG. 2, FIG. 5 shows voltage profiles for actuating signals for the primary switches 11-14 as a function of time t. The time axis is the same for all graphs. In contrast to the actuation of the primary switches in the embodiment in FIG. 2, the two bridge paths in the primary bridge 10 are actuated differently in this case. The primary switches 13 and 14 are switched on after a delay by a time difference Δt′, and hence with phase shift, in relation to the primary switches 11 and 12 notwithstanding the aforementioned dead time. In the embodiment shown, their switch-off time is not altered, on the other hand: the primary switch 13 is switched off at the same time as the primary switch 12, and the primary switch 14 is switched off at the same time as the primary switch 11. The primary switches 13, 14 therefore have a shortened switched-on period in comparison with their switched-off period. The duty ratio is less than 1, in particular also less than the duty ratio obtained as a result of the dead time τ in the embodiment in FIG. 2. Consequently, the pulsed current spikes in the current profile for the load current Iᵢₙ, which is shown in the lower graph, are less steep and high, which results in a step-down effect for the DC/DC converter. In a generalization of the approach described, the duty ratio of the primary switches 13, 14 is altered, in particular shortened, in comparison with the primary switches 11, 12, with the previously described simultaneous switching off of the crosswise-complementary primary switches representing a special case.

On the basis of a nominal voltage transformation ratio which is obtained as a result of the transformation ratio of the transformer 30, the voltage transformation ratio can be increased by the method shown in connection with FIG. 2 and can be reduced by the method shown in connection with FIG. 5. In combination, the total range of variation in the voltage transformation ratio provided by a DC/DC converter is thus advantageously increased beyond the range which can be achieved using the individual methods.

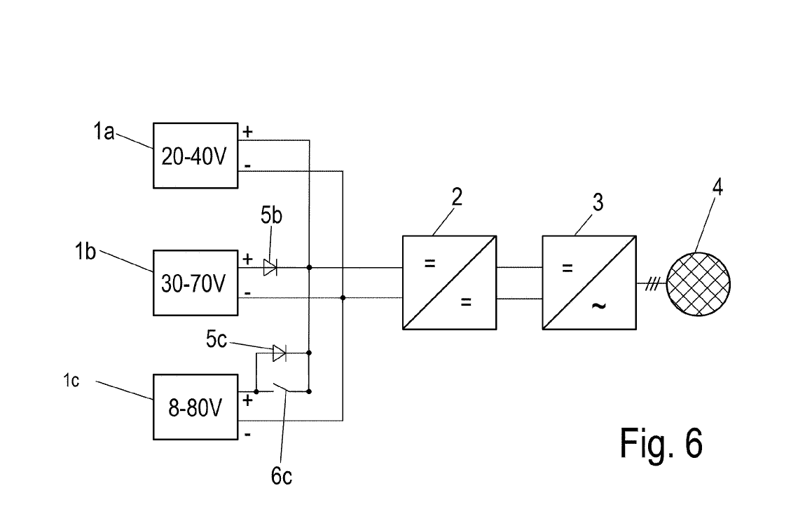

FIG. 6 shows a block diagram of a backup power system with different current sources and a DC/DC converter. By way of example, three different current sources 1a, 1b and 1c are shown which are connected to a DC/DC converter 2 by means of DC lines. The DC/DC converter 2 has a downstream inverter 3 which feeds into a—in one embodiment local—power supply grid 4. By way of example and without any limitation, the inverter 3 and the power supply grid 4 are of three-phase design. As obvious, a different number of phases is also possible, particularly one phase.

In the example shown, the current source 1a is a photovoltaic generator, e.g. a photovoltaic module or an arrangement comprising a plurality of photovoltaic modules, the current source 1b is a fuel cell arrangement and the current source 1c is a battery arrangement. In order to prevent a reverse chemical reaction (electrolysis, hydrogen production) in the fuel cell arrangement, the current source 1b is connected to the DC/DC converter 2 via a diode 5b. Similarly, a diode 5c is provided in the connection between the current source 1c and the DC/DC converter 2 in order to prevent uncontrolled charging of the battery arrangement. In order to be able to charge the battery arrangement in controlled fashion, however, a controllable switch 6c is arranged in parallel with the diode 5c. This may be a semiconductor switch or a relay which is actuated by a charging control circuit for the battery arrangement.

FIG. 6 indicates voltage ranges for varying the operating voltage for the respective current sources 1a, 1b, 1c. The variation may be caused by various operating and environmental parameters, e.g. solar irradiation, charge state, loading on the backup power system. The voltage ranges from 20 to 40 V for the photovoltaic module, 30 to 70 V for the fuel cell arrangement and 8 to 80 V for the battery arrangement.

By way of example, a battery and a capacitor store such as an ultracap may be connected in parallel in the battery arrangement. The ultracap could be used to provide power peaks in the short term, while the battery is used in one embodiment for the uniform delivery of energy over a relatively long period. Whereas the cell voltage of the battery varies only relatively little with the charge state, the residual energy in a capacitor store is typically dependent on the square of the capacitor voltage. The effect of this is that the capacitor voltage of the ultracap varies by factors, e.g. by a factor of 10, between a fully charged and a discharged state.

In general, the connection of two current sources of different type results in a wide range of variation in the input voltage for the DC/DC converter 2.

In order to adapt to the voltage varying over a wide range, the DC/DC converter 2 has a similarly wide range of variation for the transformation ratio. This ratio is provided from the DC/DC converter 2 as described in one of the previous embodiments of DC/DC converters, or from its suitability for executing one of the previously specified embodiments of a method of operation.

The disclosure is not limited to the embodiments described, which can be modified in numerous ways and augmented by a person skilled in the art. In particular, it is possible for the cited features also to be implemented in combinations other than those cited, and for further previously known methods for changing the transformation ratio of the DC/DC voltage converter to be augmented in order to attain an additional extension of the range of adjustment.

1. A DC/DC voltage converter, comprising:
a first switching bridge comprising at least two first switches coupled to an input of the DC/DC voltage converter;
a second switching bridge comprising at least two second switches coupled to an output of the DC/DC voltage converter;
a transformer coupled between the first switching bridge and the second switching bridge;
at least one capacitor; and
a switching control circuit configured to provide control signals to the first switching bridge and the second switching bridge,
wherein the first switches are switched by the switching control circuit such that a resonant circuit formed by the transformer and the at least one capacitor is operated in resonance, and
wherein the second switches are switched by the switching control circuit at the same clock frequency with a phase shift compared to the first switches, such that the second switches are switched prior to the first switches.

2. The DC/DC voltage converter as claimed in claim 1, wherein the first and second switches are switched by the switching control circuit on at zero voltage and/or at zero current.

3. The DC/DC voltage converter as claimed in claim 1, wherein the phase-shifted switching of the second switches is effected by the switching control circuit with a phase shift of greater than 0° and less than 180°.

4. The DC/DC voltage converter as claimed in claim 1, wherein the output voltage from the DC/DC voltage converter is measured and wherein a magnitude of the phase shift is adjusted by the switching control circuit based on the difference between the measured output voltage Uₒᵤₜ and a setpoint value for the output voltage.

5. The DC/DC voltage converter as claimed in claim 1, wherein a further measure for changing a voltage transformation ratio of the DC/DC voltage converter is performed by the switching control circuit in combination with the phase-shifted switching of the second switches in comparison to the first switches.

6. The DC/DC voltage converter as claimed in claim 5, wherein the further measure comprises altering the phase shift between the switching phases of the switches in the first switching bridge or the second switching bridge, wherein the first switching bridge or the second switching bridge comprises a full bridge.

7. The DC/DC voltage converter as claimed in claim 5, wherein the further measure comprises changing a duty ratio between a switched-on period and a switched-off period of one of the first switches.

8. The DC/DC voltage converter as claimed in claim 5, wherein the further measure comprises connecting and disconnecting a voltage doubler circuit comprising at least two capacitors, wherein the voltage doubler circuit is coupled to the second switching bridge.

9. The DC/DC voltage converter as claimed in claim 1, wherein the DC/DC voltage converter comprises a unidirectional DC/DC voltage converter.

10. The DC/DC voltage converter as claimed in claim 9, wherein the second switching bridge comprises a full bridge comprising two bridge paths, wherein each of the bridge paths comprise an active second switch and a diode as a passive switch.

11. A DC/DC voltage converter, comprising:
a first switching bridge configured as a full bridge comprising at least four first switches, the first switching bridge coupled to an input of the DC/DC voltage converter;
a second switching bridge comprising at least two second switches coupled to an output of the DC/DC voltage converter;
a transformer coupled between the first switching bridge and the second switching bridge;
at least one capacitor; and
a switching control circuit configured to provide control signals to the first switching bridge and the second switching bridge,
wherein the first switches are switched in crosswise synchronicity by the switching control circuit such that a resonant circuit formed by the transformer and the at least one capacitor is operated in resonance, and
wherein the second switches are switched by the switching control circuit at the same clock frequency with a phase shift compared to the first switches.

12. The DC/DC voltage converter as claimed in claim 11, wherein the second switches are switched prior to the first switches.

13. The DC/DC voltage converter as claimed in claim 11, wherein the first switching bridge and/or the second switching bridge is/are a voltage-doubling bridge.

14. The DC/DC voltage converter as claimed in claim 13, wherein the first switching bridge and/or the second switching bridge is switchable between a voltage-doubling bridge and a non-voltage-doubling bridge based on a control signal from the control circuit.

15. The DC/DC voltage converter as claimed in claim 14, wherein a bridge path in the first switching bridge and/or the second switching bridge comprises a series circuit comprising a first switch or a second switch, two capacitors and a further first switch or a second switch, wherein an additional switch is arranged in parallel with the series circuit comprising the two capacitors and is configured to selectively change the first switching bridge and/or the second switching bridge over between a voltage-doubling bridge and a non-voltage-doubling bridge.

16. A DC/DC converter, comprising:
a first switching bridge circuit configured to couple to first DC voltage terminals;
a transformer comprising a first winding coupled to an output of the first switching bridge circuit, and comprising a second winding;
a two mode second switching bridge circuit configured to couple between second DC voltage terminals and the second winding of the transformer, wherein in a first mode the second switching bridge circuit exhibits a passive path, and in a second mode the second switching bridge circuit exhibits an active path; and
a switching control circuit configured to provide control signals to the first switching bridge circuit and the second switching bridge circuit, wherein the control signals dictate the first mode or the second mode of the second switching bridge circuit.

17. The DC/DC converter of claim 16, wherein the two mode second switching bridge circuit comprises:
a first active path comprising two series-connected switches coupled together at a node connected to one end of the second winding of the transformer; and
a second path selectively switchable between another active path and the passive path based on a control signal from the switching control circuit.

18. The DC/DC converter of claim 17, wherein a node of the second path is coupled to the other end of the second winding of the transformer.

19. The DC/DC converter of claim 17, wherein the second path comprises two series-connected switches with two series-connected capacitances therebetween and a switch coupled in parallel with the two series-connected capacitances, wherein a node between the two capacitances is coupled to the other end of the second winding of the transformer, and wherein in the first mode the switch across the two capacitances is open and the two series-connected switches are closed, resulting in the second path comprising the two capacitances, and wherein in the second mode the switch across the two capacitances is closed and the series-connected switches are switched in a predetermined timing with the two series-connected switches of the first active path based on control signals from the switching control circuit.

20. The DC/DC converter of claim 16, wherein the switching control circuit is configured to provide control signals to the first switching bridge and the second switching bridge,
wherein the first switches are switched by the switching control circuit such that a resonant circuit formed by the transformer and a capacitor associated therewith is operated in resonance, and
wherein the second switches are switched by the switching control circuit at the same clock frequency with a phase shift compared to the first switches, such that the second switches are switched prior to the first switches.
